(19) United States
(12) Patent Application Publication
(10) Pub. No.: US 2014/0189645 A1
(43) Pub. Date: Jul. 3, 2014

(54) METHOD FOR DYNAMIC CONFIGURATION MANAGEMENT AND AN APPARATUS THEREOF

(71) Applicants: Cengiz Erbas, Ankara (TR); Nagehan Pala Er, Ankara (TR); Fatma Gulsah Kandemir, Ankara (TR)

(72) Inventors: Cengiz Erbas, Ankara (TR); Nagehan Pala Er, Ankara (TR); Fatma Gulsah Kandemir, Ankara (TR)

(73) Assignee: ASELSAN ELEKTRONIK SANAYI VE TICARET ANONIM SIRKETI, Ankara (TR)

(21) Appl. No.: 14/114,750

(22) PCT Filed: Apr. 27, 2012
(86) PCT No.: PCT/IB12/52123

§ 371 Date: Mar. 13, 2014

(51) Int. Cl. G06F 9/44

(52) U.S. Cl. CPC G06F 8/70
USPC 717/121

(57) ABSTRACT

The present invention relates to a dynamic configuration management method providing an automatically updated configuration management structure (100). The configuration management structure is updated according to the configuration management pattern (109) which is suggested according to the DSM (108) which is updated according to the list of components (107).

### FIELD OF THE INVENTION

The present invention relates to a dynamic configuration management method and an apparatus thereof providing an automatically updated configuration management structure.

### BACKGROUND

When a software is being developed, especially in large scale projects, in order to manage the software, a top-down analysis of the required components is needed. As a result of this top-down analysis, the required components of the software and the dependencies between these components are determined. Afterwards, software architecture is determined according to the components and the dependencies between components. This type of software architecture is called component based software architecture. The software configuration management structure regarding this software architecture is called component based software configuration management.

The dependencies between components are determined and placed in a matrix. This matrix is called dependency structure matrix (DSM). DSM can be used to group dependencies and provides a visual overall view of the dependency structure.

In time, software architecture develops and changes. As a result of this development, initially determined components may need to be constructed by multiple sub-components thus the components may need to be separated from each other. Meanwhile, software architecture has to be updated in order to reflect these changes. Accordingly, software configuration management structure has to be updated in order to reflect these changes as well.

In the state of the art, software configuration management structure is manually updated by the user. For rather small projects, the disadvantages of this method may not be challenging. However for large scale projects, where the projects consist of a large number of components and subcomponents, manual update of the software configuration management structure is prone to mistakes and consumes too much time.

The international patent document numbered WO2005006187 discloses a method for changing one software design into a second design. In order to convert a first design into a second design, design descriptions, which disclose the second software architecture, are taken and then these design descriptions and the first design are compared. The second design is developed according to the results of this comparison.

The Japanese patent document numbered JP2005135323 discloses a method for reducing development work period. In this method, a design structure matrix (DSM) is utilized in order to indicate the components which are related to each other. However this document does not disclose any information about automatically updating the configuration management structure.

### SUMMARY OF THE INVENTION

The object of the invention is to provide a dynamic configuration management method and an apparatus thereof providing an automatically updated configuration management structure during a software development process.

### BRIEF DESCRIPTION OF THE DRAWINGS

FIG. 1 is the flowchart of the dynamic configuration management method.

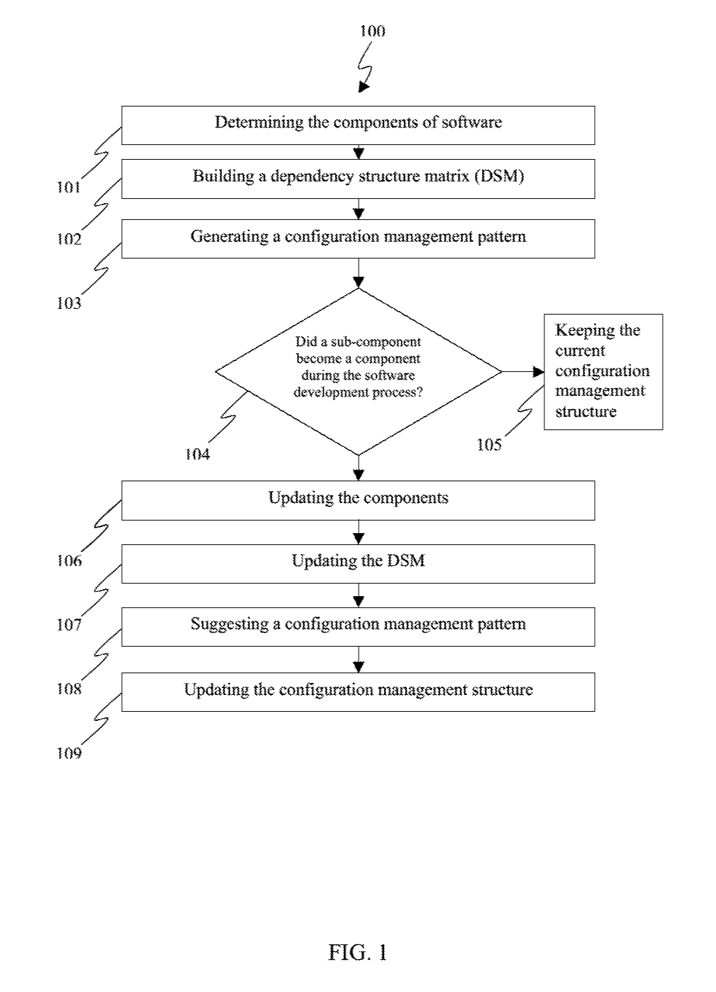

FIG. 2 is the schematic view of the dynamic configuration management apparatus

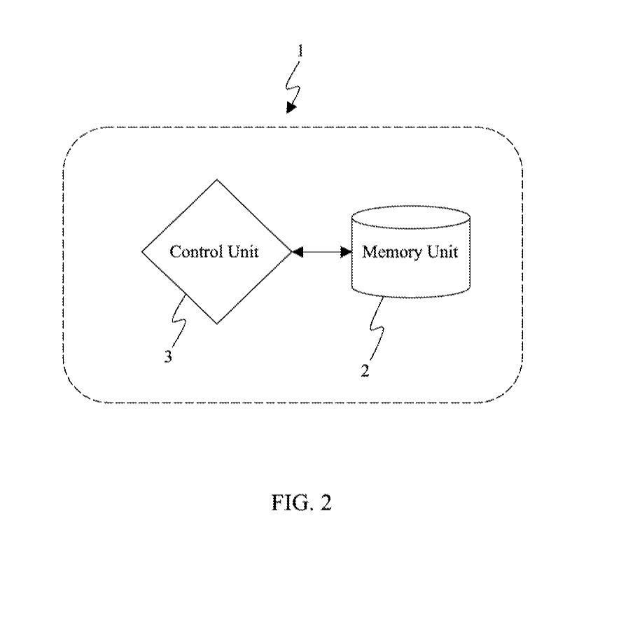

Elements shown in the figures are numbered as follows:

1. Apparatus for dynamic configuration management

2. Memory unit

3. Control unit

### DETAILED DESCRIPTION OF PREFERRED EMBODIMENTS

The inventive apparatus for dynamic configuration management (1) essentially comprises at least one memory unit (2) where the configuration management structure, the dependency structure, software components and such are stored and at least one control unit (3) which analyses the dependency structure and updates the configuration management structure.

A method for dynamic configuration management (100) comprises the steps of;
determining the components of software (101),
building a dependency structure matrix (DSM) regarding the dependencies between software components (102),
generating a configuration management pattern for each component according to the DSM (103),
determining if any of the sub-components became a component during the software development process (104),
if any of the sub-components didn't become a component keeping the current configuration management structure (105),
if any of the sub-components became a component updating the components (106),
updating the DSM (107),
suggesting a configuration management pattern according to the DSM (108),
updating the configuration management structure according to the configuration management pattern (109).

While developing a software, for the software to be manageable, a top-down analysis which yields a list a the necessary components and the sub-components that will form the software is run and the components of the software is determined thus creating an initial dependency structure matrix (101). The relationships between these components are analyzed utilizing the initial dependency structure matrix; a dependency structure matrix (DSM) showing the super-components and the sub-components is formed. (102). A configuration management pattern showing how to utilize the configuration management structure according to the DSM is generated (103). This generated configuration management pattern is related to the software component dependencies indicated by the DSM. So if the components of the software change in the development process, the DSM will also change thus affecting the configuration management pattern. In order to keep the configuration management structure updated, if any of the sub-components became a component during the software development process or not is determined (104). If none of the sub-components became a component, the current configuration management structure is kept (105). If any of the sub-components became a component, the list of the components is updated (106). As the list of the components has changed, the dependencies between these components may also have changed. So the DSM is also updated according to the list of components (107). A new configuration management pattern according to the updated DSM is suggested (108) and the configuration management structure is updated according to the configuration management pattern (109).

The suggestion of the new configuration management structure according to the configuration management pattern (in other words step 108) is realized as follows. The components in the generated DSM are checked for whether they are sub or super components. If they are sub-components a single-line component management pattern is suggested. If they are super-components a main-line component management pattern is suggested.

Main-line configuration management pattern can be defined as the pattern where changes made in follow-on branches are integrated with the main-line branch. Follow-on branches are created based on a baseline (a baseline is defined as a version of a component) of the main-line branch.

Single-line configuration management pattern can be defined as the pattern where a single branch is suggested. The related component is developed in a single line branch.

Although the present invention has been described and illustrated in detail, it is clearly understood that the same is by way of illustration and example only and is not to be taken by way of limitation, the spirit and scope of the present invention being limited only by the terms of the appended claims.

1. A method for dynamic configuration management (100) comprising the steps of:
determining the components of a software (101)
building a dependency structure matrix (DSM) regarding the dependencies between software components (102)
generating a configuration management pattern for each component according to the DSM (103);
determining if any of the sub-components became a component (104)
if any of the sub-components didn't become a component keeping the current configuration management structure (105);
if any of the sub-components became a component updating the components (106);
updating the DSM (107);
suggesting a configuration management pattern according to the DSM (108);
updating the configuration management structure according to the configuration management pattern (109).

2. The method of claim 1 wherein the components in the generated DSM are checked for whether they are sub or super components.

3. The method of claim 2 wherein a single line component management pattern is suggested if the components in the generated DSM are sub-components.

4. The method of claim 2 wherein a main-line component management pattern is suggested if the components in the generated DSM are super-components.

5. An apparatus for a dynamic configuration management (1) comprising: at least one memory unit (2) where the configuration management structure, the dependency structure, software components and such are stored; and at least one control unit (3) adapted to perform the method for dynamic configuration management (100) according to any of the preceding claims.

6. A non-transitory computer-readable medium having embodied thereon a computer program configured to cause a processor to perform the method of claim 1.

7. The method of claim 3 wherein a main-line component management pattern is suggested if the components in the generated DSM are super-components.

8. A non-transitory computer-readable medium having embodied thereon a computer program configured to cause a processor to perform the method of claim 2.

9. A non-transitory computer-readable medium having embodied thereon a computer program configured to cause a processor to perform the method of claim 3.

10. A non-transitory computer-readable medium having embodied thereon a computer program configured to cause a processor to perform the method of claim 4.

11. A computer program for instructing a computer to perform the method of claim 7.
